(19) United States
(12) Patent Application Publication
(10) Pub. No.: US 2025/0065667 A1
(43) Pub. Date: Feb. 27, 2025

(54) PENDULUM DECORATING APPARATUS

(71) Applicant: CRAYOLA LLC, EASTON, PA (US)

(72) Inventors: ROBERT HENRY, BETHLEHEM, PA (US); JOSEPH MOLL, BETHLEHEM, PA (US); REGAN JOHNSON, FLEETWOOD, PA (US); CAROLINA C. O'CONNOR, BETHLEHEM, PA (US); LEE SOKOLOWSKI, EFFORT, PA (US); YING K. HO, BETHLEHEM, PA (US)

(21) Appl. No.: 18/806,878

(22) Filed: Aug. 16, 2024

Related U.S. Application Data
(60) Provisional application No. 63/533,976, filed on Aug. 22, 2023.

(51) Int. Cl. B44D 3/22

(52) U.S. Cl. CPC B44D 3/22

(57) ABSTRACT

A pendulum decorating apparatus having a base, an arm coupled to the base and extending upward from the base, a tether coupled to a portion of the arm above the base, and a pot coupled to the tether. The pot is configured to contain a decorating material, and the pot is configured to swing with respect to the arm via the tether while releasing the decorating material through a discharge opening of the pot. The arm may be coupled to a tilt tray supported by the base with the arm and tilt tray configured to tilt together with respect to the base. The pot may include a container configured to contain the decorating material and a stopper movable to close or open the discharge opening of the pot. The pot may include a plurality of chambers each configured to contain a different color or type of decorating material.

### CROSS-REFERENCE TO RELATED APPLICATIONS

This application is based on and claims priority to U.S. Provisional Application Ser. No. 63/533,976, filed on Aug. 22, 2023, which is incorporated herein by reference in its entirety.

### BACKGROUND

Pendulum painting typically involves suspending a container holding paint above a substrate and causing the container to swing similar to a pendulum as paint is discharged from a hole in the bottom of the container. The container is typically suspended from a stationary frame that rests on a horizontal surface (e.g., the ground or a tabletop). In some instances, the container may be suspended from a ceiling joist or other part of a larger framed structure. When using conventional materials for pendulum painting, after paint is poured into the container, the user typically needs to plug the hole in the bottom of the container with their finger until they are ready to release the container to swing above the substrate being painted. For example, the user may pour paint into the container with their finger placed over the hole on the bottom of the container. The user may then raise the container and move it laterally from its neutral hanging position. After that, the user may release the container while removing their finger from the bottom of the container so that paint may be discharged through the hole. When the user wants to stop painting, they may grab the container while quickly plugging the hole so that dripping paint does not concentrate in one location on the substrate in an undesired manner.

While the paint is discharged from the swinging container, the paint may be deposited on surfaces in the vicinity of the frame other than the substrate. Thus, it is often desired to carry out the process outdoors or in another type of space, such as a garage, where the user does not mind having paint deposited throughout a relatively wide area. Further, when using conventional materials for pendulum painting, if the user desires to change the flight path of the container, they must grab the swinging container and move the container to a new location where it is again released to create the desired pattern on the substrate. If the user wants to paint a pattern on the substrate using more than one color of paint, they must first cause one container to swing above the substrate, and then replace that container with a second container holding a different color of paint. Alternatively, some painters have connected multiple paint cans together allowing them to deposit more than one color at a time. While skilled artists have used conventional pendulum painting apparatuses to create unique paintings, conventional apparatuses may be difficult to use for novices and children.

### SUMMARY

A pendulum decorating apparatus in accordance with one exemplary aspect of the invention described herein includes a base, a tilt tray supported by the base, an arm coupled to the tilt tray and extending upward from the tilt tray, a tether coupled to a portion of the arm above the tilt tray, and a pot coupled to the tether. The pot is configured to contain a decorating material, and the pot is configured to swing with respect to the arm via the tether while releasing the decorating material through a discharge opening of the pot. The tilt tray is configured to tilt with respect to the base, and the arm is configured to tilt with respect to the base when the tilt tray tilts with respect to the base.

In some embodiments, the tether extends downward from the arm in a direction parallel to a vertical axis of the base when the tether is not swinging with respect to the arm, and the tilt tray and the arm are configured to tilt with respect to the base about at least a first axis that is perpendicular to the vertical axis. The tilt tray and the arm may further be configured to rotate with respect to the base about at least a second axis that is parallel to the vertical axis.

Further, in some embodiments, one of the base or the tilt tray comprises a concave surface and the other of the base or the tilt tray comprises a convex surface that engages the concave surface to allow the tilt tray to tilt with respect to the base.

In some embodiments, a decorating tray is coupled to the base. The decorating tray is positioned above the tilt tray and configured to hold an item for decoration by the decorating material released from the pot. The decorating tray may be rotatably mounted to the base, and the decorating tray may be configured to rotate with respect to the base separate from the tilt tray tilting with respect to the base.

Further, in some embodiments, the pot includes a container that is configured to contain the decorating material and defines the discharge opening. The pot further includes a stopper that is movable with respect to the container between a closed position, in which the stopper blocks the discharge opening to substantially prevent the decorating material from being released through the discharge opening, and an open position, in which the decorating material can be released through the discharge opening. The stopper may be biased to the closed position. Further, the pot may include a spring that engages the container and the stopper. The spring exerts a bias force on the stopper to bias the stopper to the closed position. The stopper is coupled to the tether, and the stopper is configured to move to the open position when the weight of the container and the decorating material in the container is greater than the bias force of the spring.

In some embodiments, the pot includes a plurality of chambers each configured to contain a different color or type of decorating material. Each of the chambers is in fluid communication with the discharge opening or another discharge opening defined by the pot.

In some embodiments, a wall is coupled to the tilt tray and extends upward from the tilt tray. A diameter of the wall, a height of the wall, and a length of the tether may be configured to retain decorating material released by the pot within a volume defined by the wall and the tilt tray. The tether may be flexible or rigid.

A pendulum decorating apparatus in accordance with another exemplary aspect of the invention described herein includes a base, a decorating tray supported by the base and configured to hold an item for decoration, an arm coupled to the base and extending upward above the decorating tray, a tether coupled to a portion of the arm above the decorating tray, and a pot coupled to the tether. The pot is configured to swing with respect to the arm via the tether. The pot includes a container that is configured to contain a decorating material and that defines a discharge opening. The pot further includes a stopper that is movable with respect to the container between a closed position, in which the stopper blocks the discharge opening to substantially prevent the decorating material from being released through the discharge opening, and an open position, in which the decorating material can be released through the discharge opening while the pot swings.

In some embodiments, the stopper is biased to the closed position. The pot may further include a spring that engages the container and the stopper. The spring exerts a bias force on the stopper to bias the stopper to the closed position. The stopper is coupled to the tether, and the stopper is configured to move to the open position when the weight of the container and the decorating material in the container is greater than the bias force of the spring.

In some embodiments, the pot includes a plurality of chambers each configured to contain a different color or type of decorating material. Each of the chambers is in fluid communication with the discharge opening or another discharge opening defined by the pot when the stopper is in the open position.

In some embodiments, the tether is flexible or rigid.

In some embodiments, the decorating tray is configured to rotate with respect to the base.

In some embodiments, the apparatus includes a tilt tray supported by the base. The tilt tray is positioned below the decorating tray, and the tilt tray is configured to tilt with respect to the base. A wall may be coupled to the tilt tray and extend upward from the tilt tray. A diameter of the wall, a height of the wall, and a length of the tether may be configured to retain decorating material released by the pot within a volume defined by the wall and the tilt tray.

In another exemplary aspect of the invention described herein, a pendulum decorating apparatus includes a base, a decorating tray supported by the base and configured to hold an item for decoration, an arm coupled to the base and extending upward above the decorating tray, a tether coupled to a portion of the arm above the decorating tray, and a pot coupled to the tether. The pot is configured to contain a decorating material, and the pot is configured to swing with respect to the arm via the tether. The pot includes a plurality of chambers each configured to contain a different color or type of decorating material. Each of the chambers is in fluid communication with at least one discharge opening of the pot that is configured to release the decorating material held by the chambers while the pot swings.

In some embodiments, the tether is flexible or rigid.

In some embodiments, the decorating tray is configured to rotate with respect to the base.

In some embodiments, the apparatus includes a tilt tray supported by the base. The tilt tray is positioned below the decorating tray, and the tilt tray is configured to tilt with respect to the base. A wall may be coupled to the tilt tray and extend upward from the tilt tray. A diameter of the wall, a height of the wall, and a length of the tether may be configured to retain decorating material released by the pot within a volume defined by the wall and the tilt tray.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a pendulum decorating apparatus in accordance with an exemplary embodiment of the invention described herein;

FIG. 2 is another perspective view of the pendulum decorating apparatus shown in FIG. 1;

FIG. 3 is a top plan view of the pendulum decorating apparatus shown in FIG. 1;

FIG. 4 is a partially exploded view of the pendulum decorating apparatus shown in FIG. 1;

FIG. 5 is a perspective, exploded view of a base and a tray support of the pendulum decorating apparatus shown in FIG. 1;

FIG. 6 is a cross-sectional view taken through the line 6-6 shown in FIG. 3;

FIG. 7 is a detail view of the area identified in FIG. 6 as 7;

FIG. 8 is a perspective view of a pot of the pendulum decorating apparatus shown in FIG. 1;

FIG. 9 is a perspective view of a bottom of the pot shown in FIG. 8;

FIG. 10 is a top plan view of the pot shown in FIG. 8;

FIG. 11 is an exploded view of the pot shown in FIG. 8;

FIG. 12 is a cross-sectional view taken through the line 12-12 in FIG. 10 and showing a stopper of the pot in a closed position;

FIG. 13 is a cross-sectional view similar to FIG. 12 but showing the stopper in an open position;

FIG. 14 is a perspective view of the pendulum decorating apparatus showing the pot swung outward from the neutral position shown in FIG. 1;

FIG. 15 is a front elevational view of the pendulum decorating apparatus showing a tilt tray tilted with respect to a base of the apparatus along one axis;

FIG. 16 is a side elevational view of the pendulum decorating apparatus showing the tilt tray tilted with respect to the base along another axis;

FIG. 17 is a top plan view of the pendulum decorating apparatus showing a decorating tray rotated from the position shown in FIG. 3;

FIG. 18 is a partially exploded view of a wall of the pendulum decorating apparatus shown in FIG. 1;

FIG. 19 is a perspective view of four alternative pots that may be used with the pendulum decorating apparatus shown in FIG. 1;

FIG. 20 is a perspective view of a launch pad that may be used with the pendulum decorating apparatus shown in FIG. 1;

FIG. 21 is a perspective view of the launch pad shown in FIG. 20;

FIG. 22 is a top plan view showing an exemplary pattern of paint dispensed by the pendulum decorating apparatus;

FIG. 23 is a perspective view of an alternative embodiment of pot that may be used with the pendulum decorating apparatus shown in FIG. 1;

FIG. 24 is a perspective view of a bottom of the pot shown in FIG. 23;

FIG. 25 is a cross-sectional view of the pot shown in FIG. 23; and

FIG. 26 is another cross-sectional view of the pot shown in FIG. 23.

### DETAILED DESCRIPTION OF EXEMPLARY EMBODIMENTS

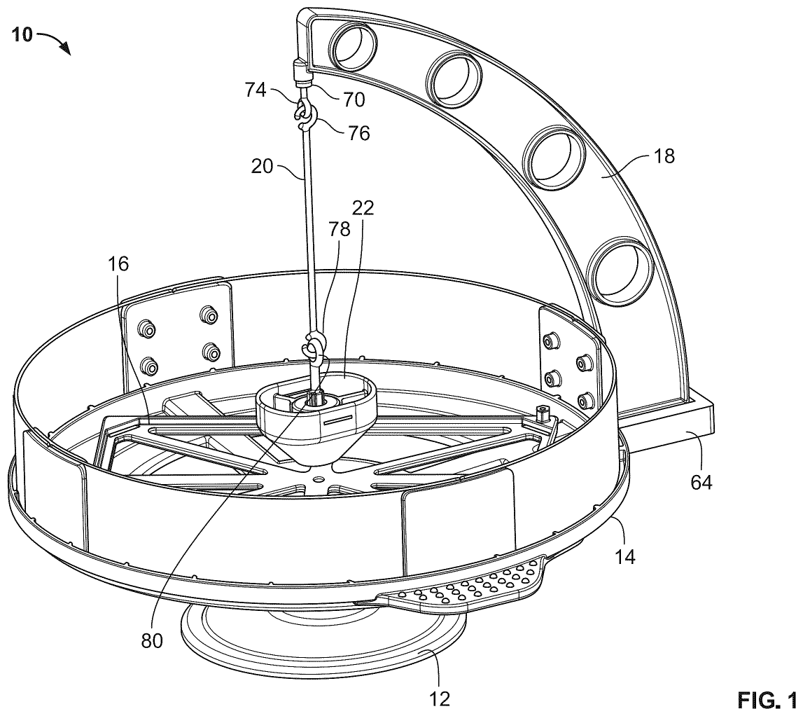

A pendulum decorating apparatus in accordance with one embodiment of the invention described and claimed herein is identified generally as 10 in FIG. 1. As described in more detail below, the pendulum decorating apparatus is configured for use to decorate an item via a pot that releases a decorating material on the item as the pot swings above the item. In one embodiment, the decorating material is paint contained by the pot, and the item is a substrate desired to be painted, such as paper or cardstock. The paint may be a CRAYOLA® Washable Paint.

Referring to FIG. 1, the pendulum decorating apparatus 10 broadly includes a base 12, a tilt tray 14 supported by the base 12, a decorating tray 16 supported by the base 12, an arm 18 mounted to the tilt tray 14 and extending upward from the tilt tray 14, a tether 20 mounted to the arm 18 above the tilt tray 14, and a pot 22 mounted to a lower end of the tether 20.

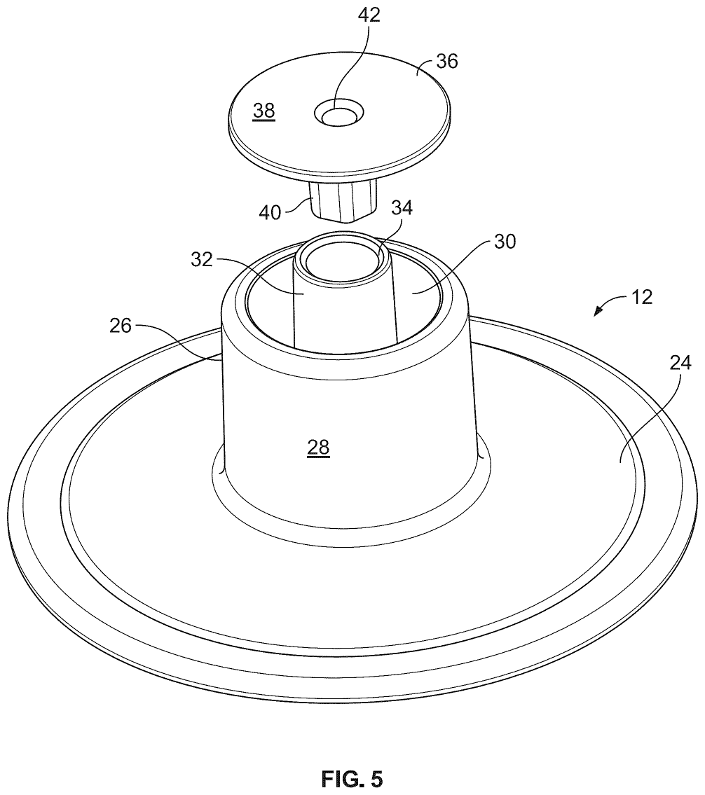

As shown in FIG. 5, the base 12 has a lower support 24 that is circular and designed for supporting the pendulum decorating apparatus 10 on a horizontal surface, such as a tabletop or countertop. A first post 26 extends upward from the middle of the lower support 24. The first post 26 includes a cylindrical side wall 28 extending upward from the lower support 24, and a concave surface 30 extending downward from an upper edge of the side wall 28. A second post 32 extends upward from a lower edge of the concave surface 30. The second post 32 is generally vertical and centered with respect to the side wall 28. The second post 32 includes an opening 34 at its upper end. A tray support 36 is supported by the second post 32. The tray support 36 includes a round base 38 and a protrusion 40 extending downward from the base 38. The protrusion 40 is configured for insertion through the opening 34 to support the tray support 36 on the second post 32. A depression 42 in the center of the base 38 is configured for rotatably supporting the decorating tray 16, as described in more detail below.

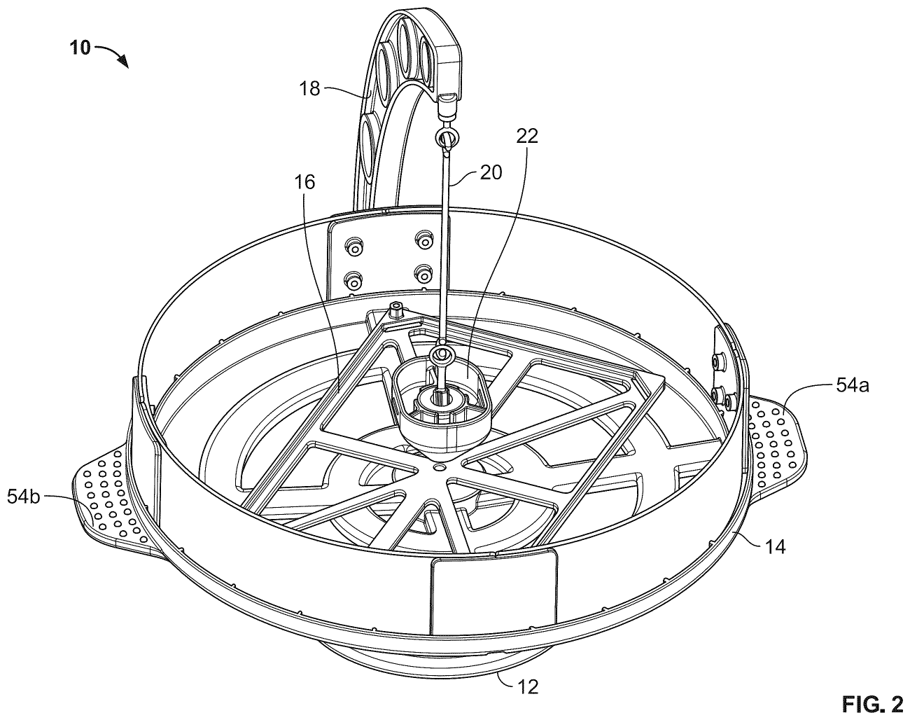

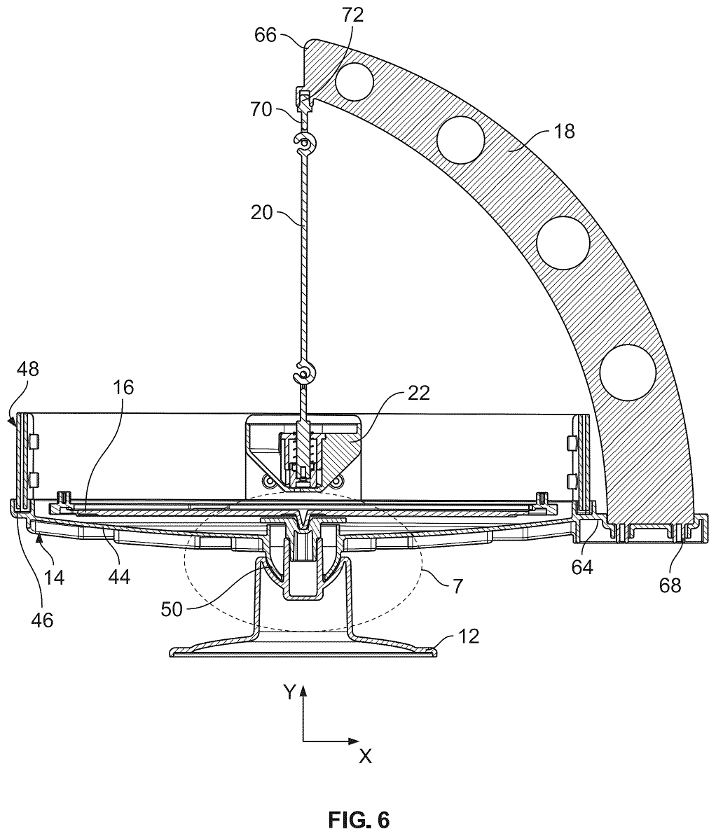

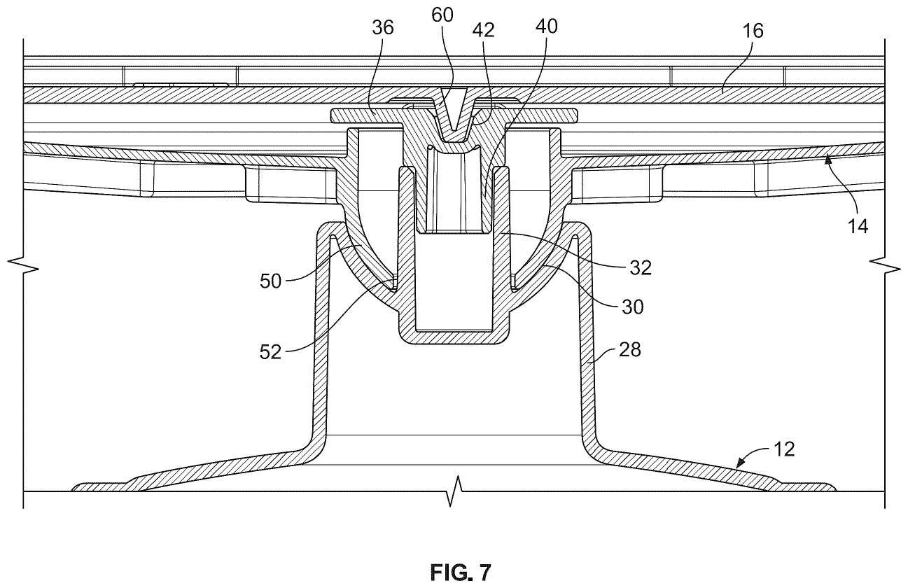

Referring to FIGS. 6 and 7, the tilt tray 14 is supported by the concave surface 30 of the base 12 in a manner that allows the tilt tray to tilt and rotate with respect to the base 12. The tilt tray 14 includes a bowl 44 (FIG. 6) with a relatively wide diameter that is configured to catch and retain paint released from the pot 22. A notch 46 at a peripheral edge of the bowl 44 receives a lower end of a wall 48 that extends upward from the tilt tray 14. The wall 48 is configured to prevent paint from splashing outside of the volume of space above the bowl 44. A convex surface 50 extends downward from a center of the bowl 44. As shown best in FIG. 7, the convex surface 50 engages the concave surface 30 of the base 12 to form a ball and socket joint that allows the tilt tray 14 to tilt with respect to the base 12. An opening 52 in the center of the convex surface 50 receives the second post 32 of the base. As the tilt tray 14 tilts with respect to the base 12, the tray support 36 and decorating tray 16 remain stationary because they are mounted on the base 12 separate from the tilt tray 14. As shown in FIG. 2, handles 54a-b joined to and extending outward from opposite sides of the bowl 44 may be manipulated by a user to tilt the tilt tray 14 with respect to the base 12.

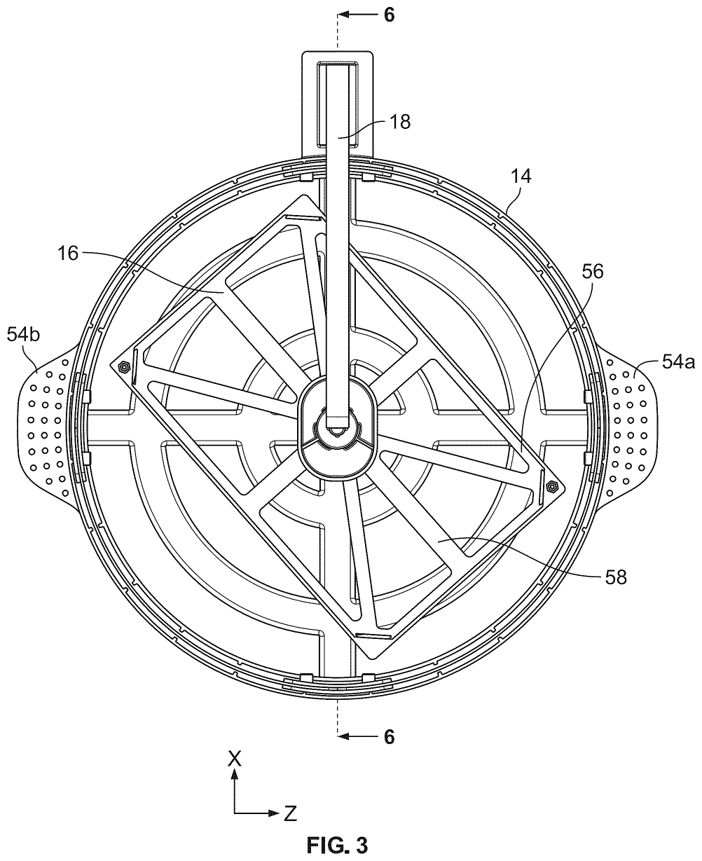

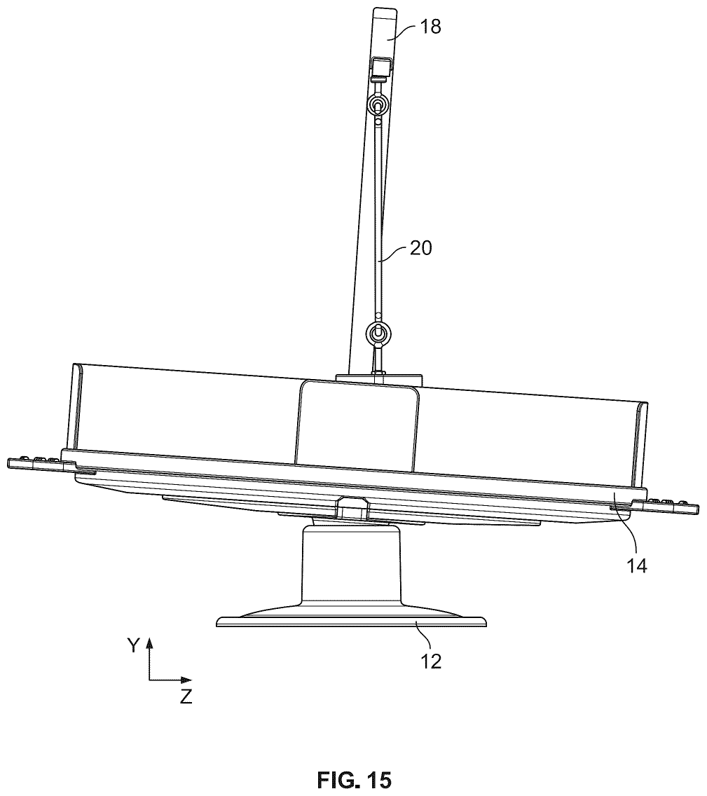

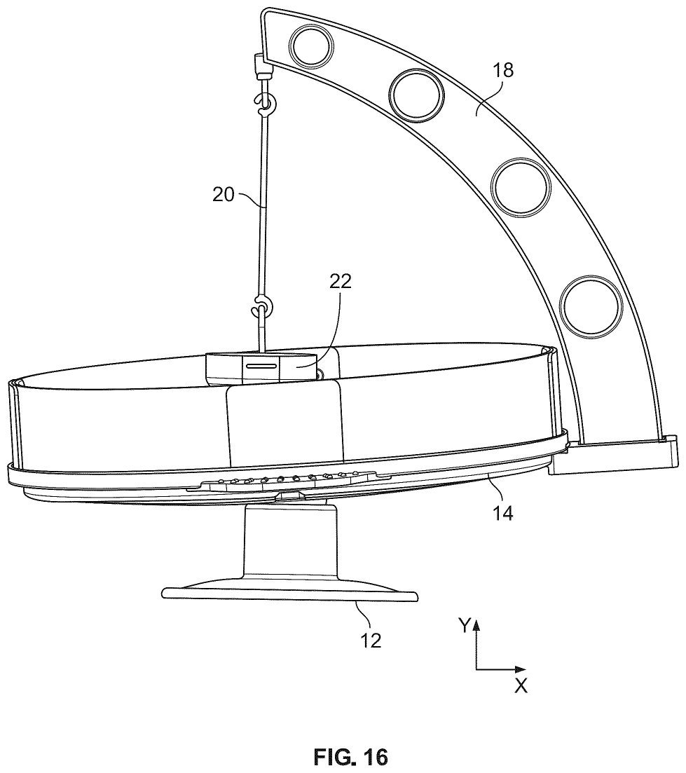

FIG. 6 shows an imaginary y axis that vertically extends through a center of the tilt tray 14 and an x axis extending perpendicular thereto. A z axis shown in FIG. 3 is perpendicular to the y and x axes. The base 12 may be supported by a surface parallel to a plane extending through the x and z axes. The tilt tray 14 may be configured to tilt with respect to the base 12 about any axis in a plane parallel to the x and z axes. For example, FIG. 15 shows the tilt tray 14 tilted about an axis parallel to the x axis, and FIG. 16 shows the tilt tray 14 tilted about an axis in a plane parallel to the x-z plane and oriented at an angle to both the x and z axes. Further, the tilt tray 14 may be configured to rotate with respect to the base 12 about the y axis.

The tilt tray 14 and base 12 may engage or be coupled to each other with an alternative joint structure that allows the tilt tray 14 to tilt with respect to the base 12 along one or more axes other than the ball and socket or spherical joint shown in the drawings. For example, the tilt tray 14 and base 12 may be coupled with a revolute joint or a universal joint. The tilt tray 14 and base 12 may further be integrally formed together from a flexible material allowing tilting of the tilt tray 14 with respect to the base 12. Further, the concave and convex surfaces of the base 12 and tilt tray 14 may be reversed such that the base 12 has a convex surface that engages a concave surface of the tilt tray 14. In one alternative embodiment, the tilt tray 14 may be connected to the base 12 with a spring. For example, a semi-rigid, vertical spring may connect the tilt tray 14 to the base 12 to allow the tilt tray 14 to tilt with respect to the base 12. In another embodiment, the tilt tray 14 and the base 12 may have opposing concave surfaces that each receive part of a ball. With the ball positioned between the tilt tray 14 and the base 12, the tilt tray 14 may tilt with respect to the base 12 by rotating around the ball. The ball may be made from a low friction material such as an acetal homopolymer (e.g., DELRIN® acetal homopolymer).

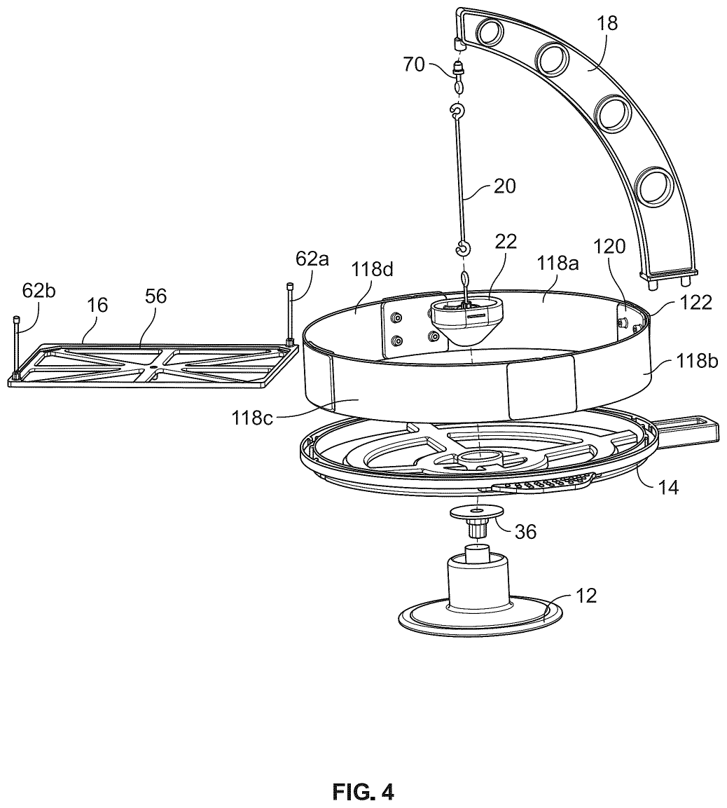

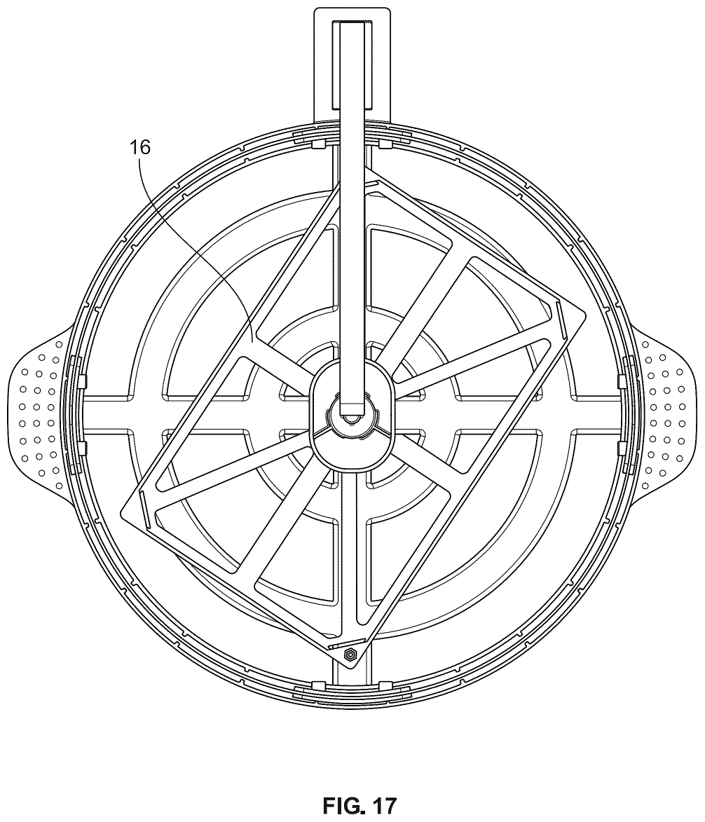

As shown in FIG. 3, the decorating tray 16 includes a rectangular frame 56 with supports, one of which is identified as 58, extending between sides or corners of the frame 56. The decorating tray 16 is generally configured for supporting a sheet of material for decoration, such as a piece of paper, cardboard, cardstock, or canvas. The decorating tray 16 may, however, be configured to hold other types of items for decoration. For example, the decorating tray 16 may be configured to hold any type of two dimensional material, such as paper, a clear or opaque sheet of plastic, a canvas sheet, a board, or a small framed canvas. The decorating tray 16 may also be configured or adjustable to hold any suitable type of three dimensional item, such as an item sculpted with a modeling compound (e.g., CRAYOLA® modeling compound). As shown in FIG. 7, the decorating tray 16 is supported by the tray support 36 above the tilt tray 14. A protrusion 60 extending downward from a center of the decorating tray 16 is received by the depression 42 of the tray support 36. The mating protrusion 60 and depression 42 allow the decorating tray 16 to rotate with respect to the base 12. The decorating tray 16 is rotatable with respect to the base 12 separate from the tilt tray 14 rotating and tilting with respect to the base 12. As shown in FIG. 4, the decorating tray 16 may include posts 62a-b extending upward from opposing corners of the frame 56 that a user may tap or press to rotate the decorating tray 16. The posts 62a-b may be removably received by receptacles at opposing corners of the frame 56. FIG. 17 shows the decorating tray 16 rotated from the position shown in FIG. 3.

Referring to FIG. 6, the arm 18 mounts to an arm bracket 64 of the tilt tray 14, which extends laterally outward from the bowl 44 beyond the wall 48. The arm 18 extends upward from the tilt tray 14, and the arm 18 is curved such that a free end 66 of the arm 18 is positioned above a center of the tilt tray 14. The arm 18 mounts to the arm bracket 64 with posts 68 that snap into receptacles of the arm bracket 64. The arm 18 may be mounted to the tilt tray 14 by other means, such as fasteners. Further, the arm 18 may be integrally formed with the tilt tray 14. The arm 18 is fixedly mounted to the tilt tray 14 such that the arm 18 tilts with respect to the base 12 when the tilt tray 14 tilts with respect to the base 12.

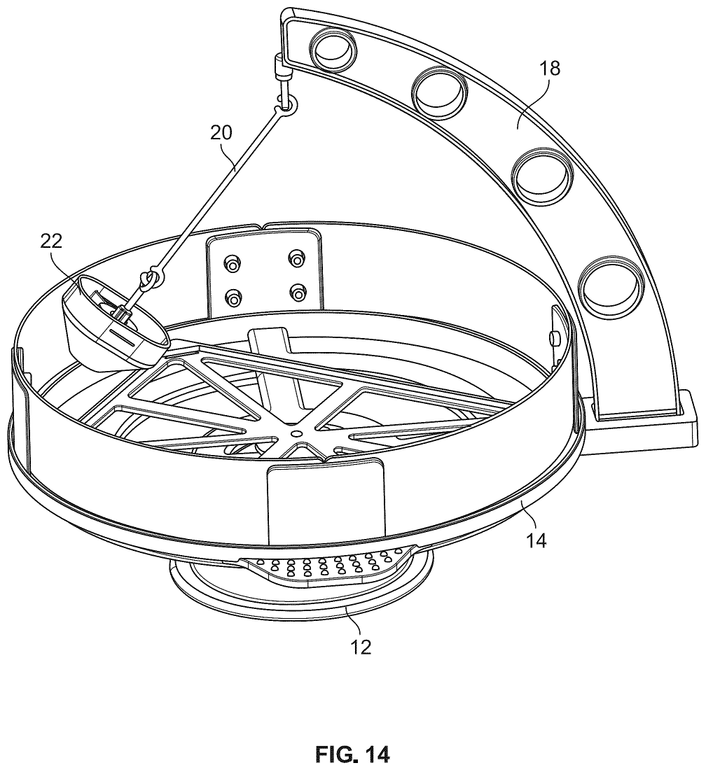

The tether 20 mounts to the free end 66 of the arm 18 with a hanger 70. The hanger 70 has a post 72 that snaps in to a receptacle of the arm 18. The hanger 70 may alternatively be mounted to the arm 18 in a different manner or be formed integrally with the arm 18. As best shown in FIG. 1, the hanger 70 has a ring 74 opposite the post 72. A hook 76 on an upper end of the tether 20 is inserted through the ring 74 to mount the tether 20 to the arm 18. A hook 78 on a lower end of the tether 20 is inserted through a ring 80 of the pot 22 to mount the pot 22 to the tether 20. The tether 20 may be either flexible (e.g., formed from a textile or string) or rigid (e.g., formed from a rigid polymeric material). In a neutral position when the tether 20 is not swinging on the ring 74 (FIG. 1), the tether 20 extends downward from the arm 18 along the y axis shown in FIG. 6. The connection between the tether 20 and the arm 18 allows the tether 20 and pot 22 to swing around in the volume of space above the bowl 44 of the tilt tray 14 with the pivot point being where the hook 76 engages the ring 74. For example, FIG. 14 shows the tether 20 and pot 22 swung upward and outward from their neutral position. Since the arm 18 is fixedly mounted to the tilt tray 14, when the tilt tray 14 tilts, the pivot point of the tether 20 and pot 22 changes (i.e., the ring 74 moves) thereby changing the swinging path of the pot 22. The pot 22 and decorating material contained therein has a weight that allows the pot 22 to swing around similar to a pendulum when the pot 22 is raised to a position other than the neutral position and released.

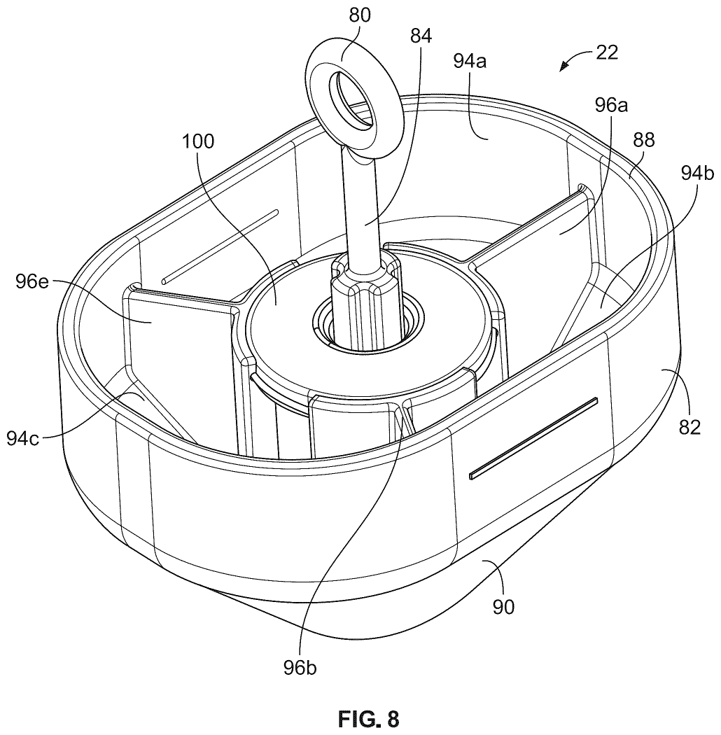

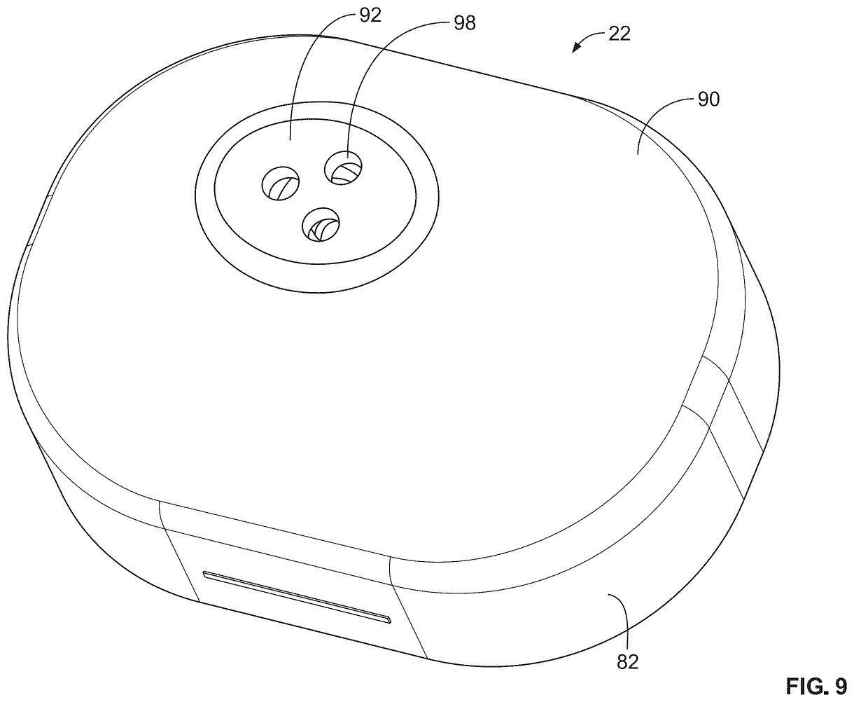

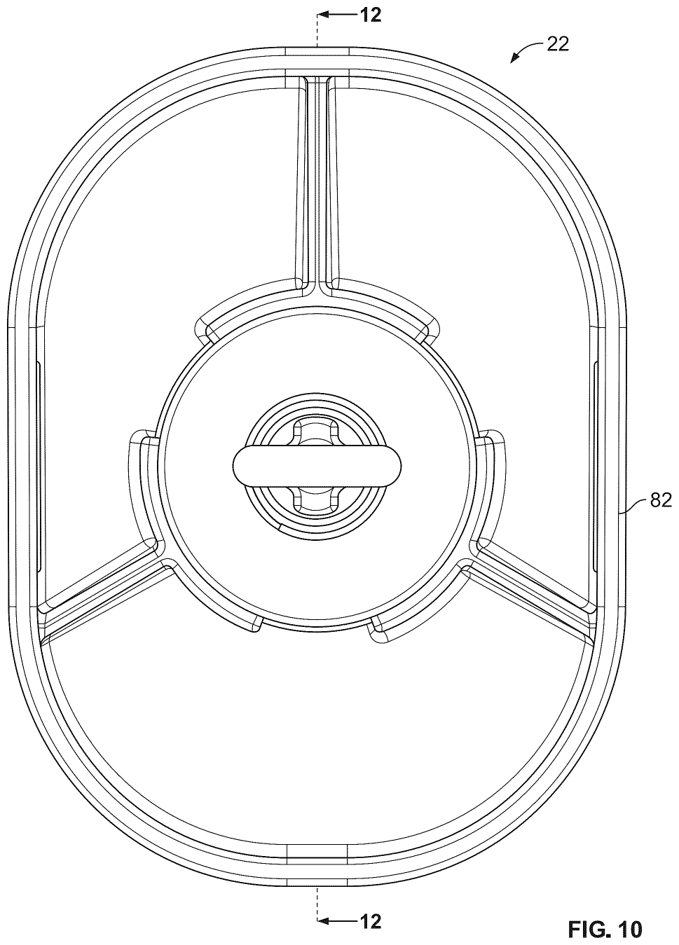

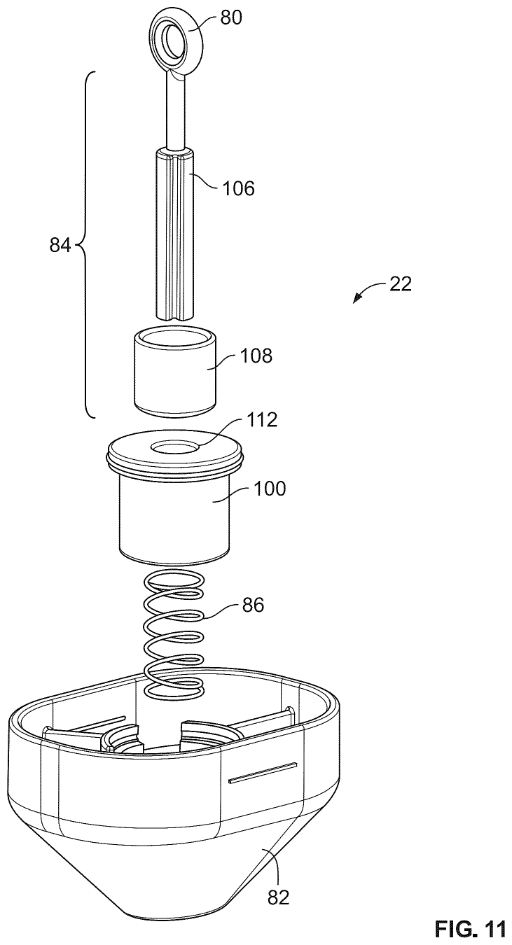

The pot 22 is described below with reference to FIGS. 8-13. The pot 22 includes a container 82, a stopper 84, and a spring 86 (FIGS. 11-13) that biases the stopper 84 to a closed position with respect to the container 82. The container 82 is generally bowl shaped with an open top 88 (FIG. 8) and a side wall 90 that tapers downward and inward to a lower wall 92 (FIG. 9) having a smaller size than the open top 88. The side wall 90 and lower wall 92 define an interior space configured to contain a decorating material, e.g., paint. The interior space is divided into three chambers 94a-c by interior dividers 96a-c. The three chambers 94a-c may each contain a different color or type of decorating material. As shown in FIG. 9, three discharge openings, one of which is identified as 98, are formed in the lower wall 92. Decorating material within the chambers 94a-c may be released through the discharge openings 98 when the stopper 84 is in its open position, described below.

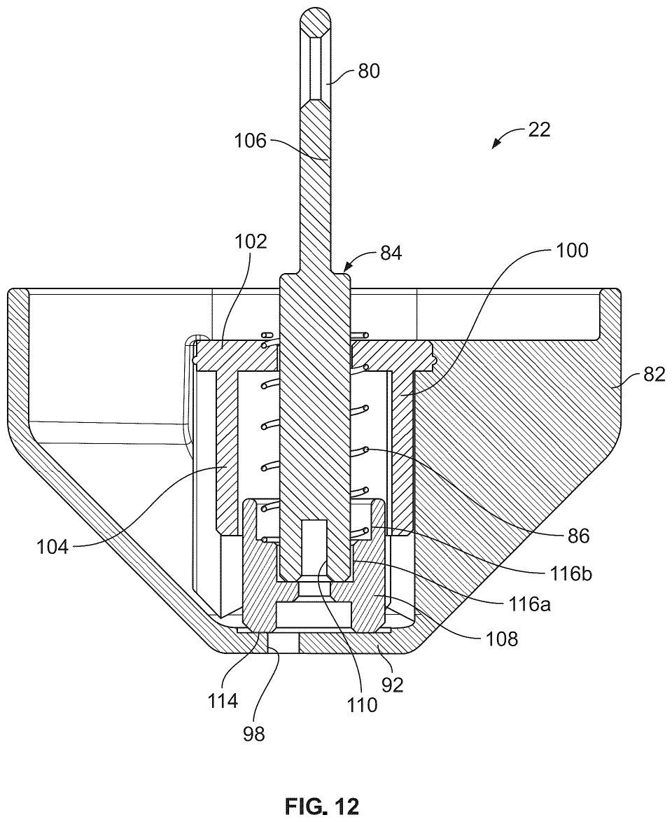

The container 82 also includes a removable spring cylinder 100 (FIG. 8) that engages the dividers 96a-c. For example, the spring cylinder 100 may engage an upper portion of the dividers 96a-c via a snap fit connection. As shown in FIG. 12, the spring cylinder 100 has an upper wall 102 that engages one end of the spring 86 to bias the stopper 84 to its closed position. The spring cylinder 100 further has a side wall 104 extending downward from the upper wall 102. The side wall 104 defines an opening at its lower end into which a portion of the stopper 84 may move as the stopper 84 moves between its closed and open positions. The side wall 104 may guide movement of the stopper 84.

As shown in FIG. 11, the stopper 84 is formed from two parts, a post 106 and a plug 108. The post 106 includes the ring 80 at one end, and the opposite end of the post 106 has a threaded opening 110 (FIG. 12) that receives a fastener to mount the plug 108 to the post 106. The post 106 has a diameter that allows it to be inserted through an opening 112 of the spring cylinder 100. As shown in FIG. 12, the spring 86 is positioned around the post 106 inside of the spring cylinder 100. The plug 108 is mounted to the end of the post 106 to capture the spring 86 between the plug 108 and the spring cylinder 100. The plug 108 is generally cylindrical and includes a lower sealing surface 114, shown in FIG. 12, that engages the lower wall 92 of the container 82 when the stopper 84 is in the closed position shown in FIG. 12. The sealing surface 114 has a diameter that is large enough to seal the discharge openings 98 from the paint or other decorating material within the container 82. The opposite end of the plug 108 has a recess with a first section 116a that receives an end of the post 106, and a second section 116b of wider diameter that receives an end of the spring 86.

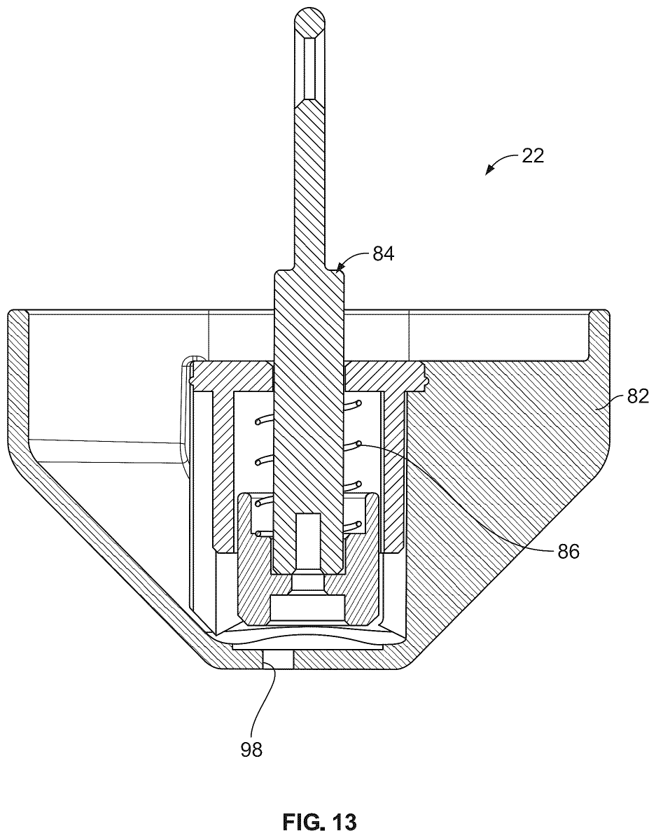

The stopper 84 is movable between the closed position shown in FIG. 12 and the open position shown in FIG. 13 based on a weight of the container 82 and the decorating material contained in the container 82. When the weight of the container 82, including the decorating material contained therein is greater than a bias force of the spring 86, the spring 86 is compressed as the container 82 moves downward relative to the stopper 84. This moves the stopper 84 to the open position relative to the container 82. In the open position, shown in FIG. 13, the decorating material within the container 82 is in fluid communication with the discharge openings 98 and can be released through the discharge openings 98. The spring 86 may be selected relative to the weight of the container 82 such that the spring 86 biases the stopper 84 to the closed position when the container 82 is empty or nearly empty of decorating material. Thus, when the decorating material has been released from the container 82, the stopper 84 moves to the closed position. When filling the container 82 with decorating material, or when the container 82 is full, the container 82 may be supported by a user's hand or surface to keep the stopper 84 in the closed position. When it is desired to decorate an item with the pot 22, the stopper 84 is hung on the tether 20 and the container 82 is released from the user's hand to swing above the decorating tray 16. Once the container 82 is released, the stopper 84 moves to the open position to allow the decorating material to be released on the item supported by the decorating tray 16.

Each of the chambers 94a-c of the container 82 are in fluid communication with each of the discharge openings 98 when the stopper 84 is in the open position. Alternatively, when the stopper 84 is in the open position, each of the chambers 94a-c may be placed into fluid communication with its own discharge opening that is divided from the discharge openings for the other chambers. The pot 22 may also include other types of stoppers other than a spring biased stopper. For example, the pot 22 may include an electrically actuated stopper. In one embodiment, the stopper may be a resilient sheet of material with posts configured to be received by the discharge openings 98 (FIG. 9) in the bottom of the pot 22. The sheet and posts may be molded rubber. A side of the sheet may be fastened to the bottom of the pot 22 adjacent the discharge openings 98. An opposite side of the sheet may have an extension configured for grasping by a user to pull the stopper downward and remove the posts from the discharge openings 98 as the user begins to swing the pot 22. In another embodiment, the stopper may be a plate that is fastened to the bottom of the pot 22 adjacent the discharge openings. The plate may be fastened with a screw, rivet, or other type of fastener that allows the plate to pivot about the fastener. The plate may be pivoted to a closed position, in which it blocks the discharge openings 98, and an open position allowing paint to flow through the discharge openings 98.

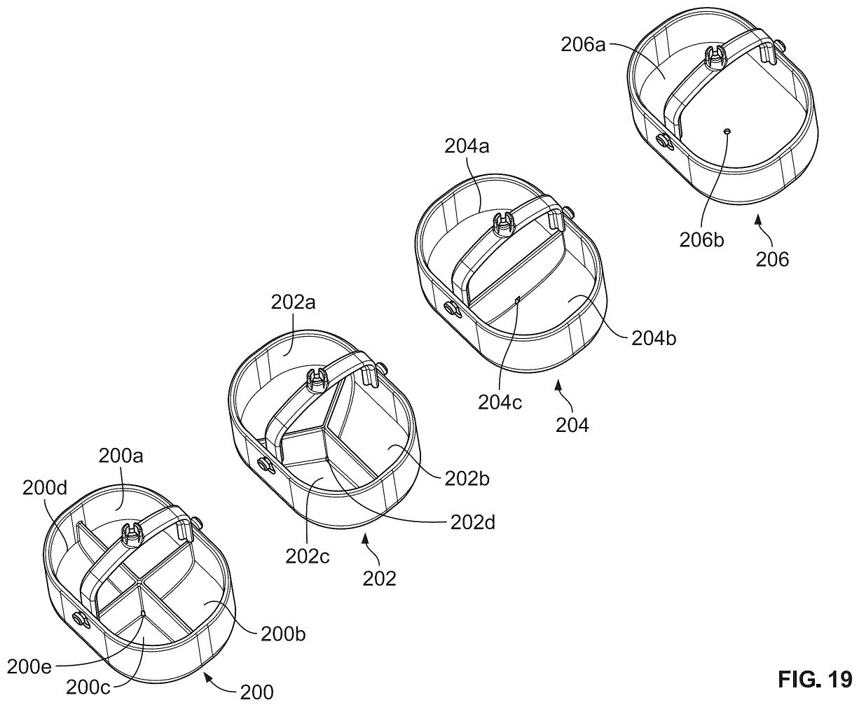

Further, in at least some embodiments, the pendulum decorating apparatus 10 may include a pot without a stopper. For example, FIG. 19 described below shows different types of pots each having a discharge opening that is always in fluid communication with decorating material within the pot. In use, a user may plug his or her finger over the bottom of the discharge opening to stop the decorating material from being released from the pot at undesired times. In addition, the pot 22 may be configured to have more or less than three chambers 94a-b. For example, the pot 22 may be configured to only have a single chamber that contains material released through the discharge openings 98 when the stopper 84 is in the open position.

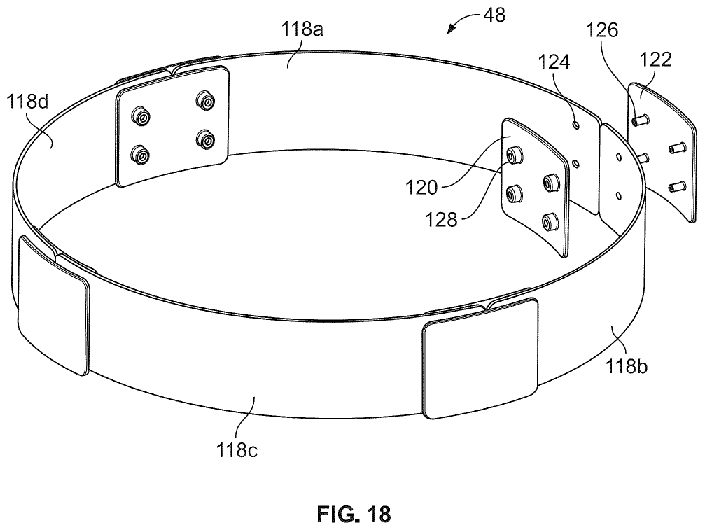

As shown in FIG. 18, the wall 48 is formed from four elongate sheets 118a-d that are joined together with inner and outer clips, one pair of which is identified as 120 and 122. Each end of each sheet 118a-d includes a pair of holes, one of which is identified as 124. The outer clips 122 include four protrusions, one of which is identified as 126, that extend through the holes 124 on adjacent sheets 118a-d. The inner clips 120 include four receptacles, one of which is identified as 128, that receive the protrusions 126 on the outer clips 122. The inner and outer clips 120, 122 may snap fit together to form the completed wall 48.

FIG. 19 shows four alternative types of pots 200, 202, 204, and 206 that may be used with the pendulum decorating apparatus 10 in lieu of pot 22. Each of the pots 200, 202, 204, and 206 has at least one chamber for containing a decorating material, and the chamber is in fluid communication with a discharge opening at the bottom of the pot. The pot 200 has four chambers 200a-d divided by dividers extending across the pot, and each of the chambers 200a-d is in fluid communication with a discharge opening 200e. The pot 202 has three chambers 202a-c divided by dividers extending across the pot, and each of the chambers 202a-c is in fluid communication with a discharge opening 202d. The pot 204 has two chambers 204a-b divided by a divider extending across the pot, and each of the chambers 204a-b is in fluid communication with a discharge opening 204c. The pot 206 has a single chamber 206a in fluid communication with a discharge opening 206b.

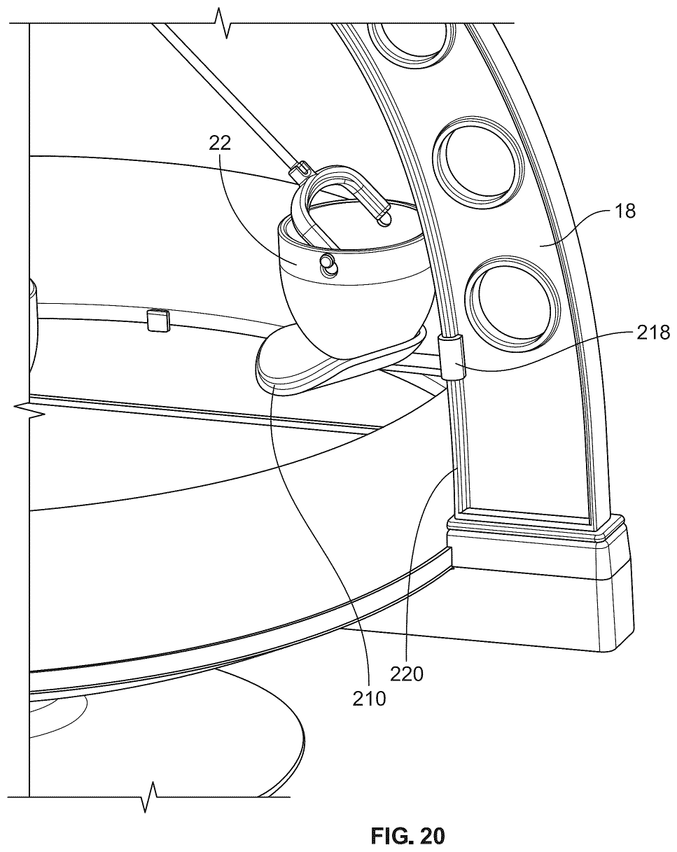

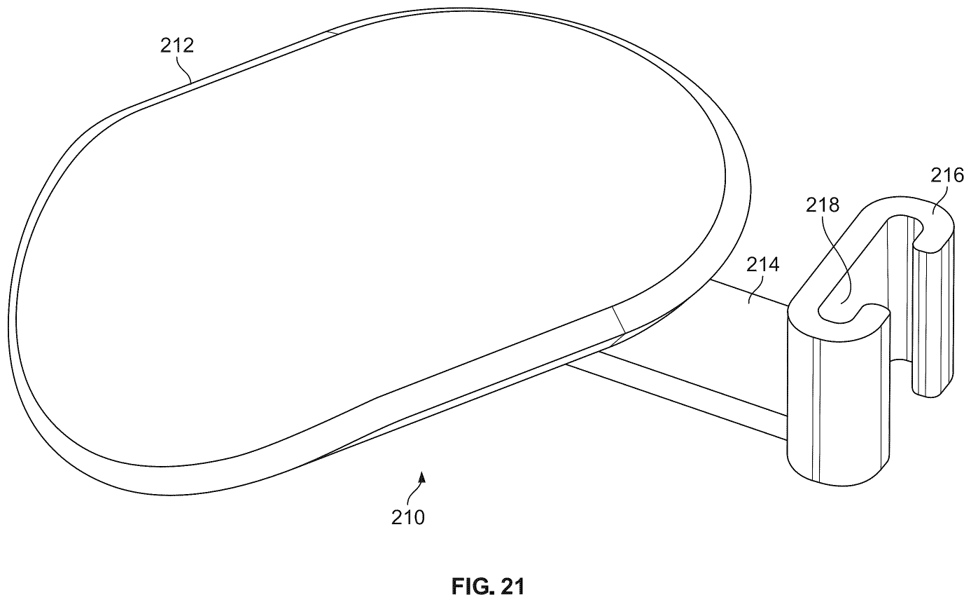

FIGS. 20 and 21 show a launch pad 210 that may be used with the pendulum decorating apparatus 10. As shown in FIG. 20, the launch pad 210 provides a place for the pot 22 to rest before it is released to swing above the decorating tray 16. The pot 22 may also be filled with paint or other decorating material while it is supported by the launch pad 210. As shown in FIG. 21, the launch pad 210 includes a support 212, on which the pot 22 may be placed, an arm 214 extending outward from the support 212, and a clip 216 at an end of the arm 214. The clip 216 defines a recess 218 configured for receiving a flange 220 of the arm 18 (FIG. 20). The clip 216 may be configured to removably snap on to the flange 220 of the arm 18.

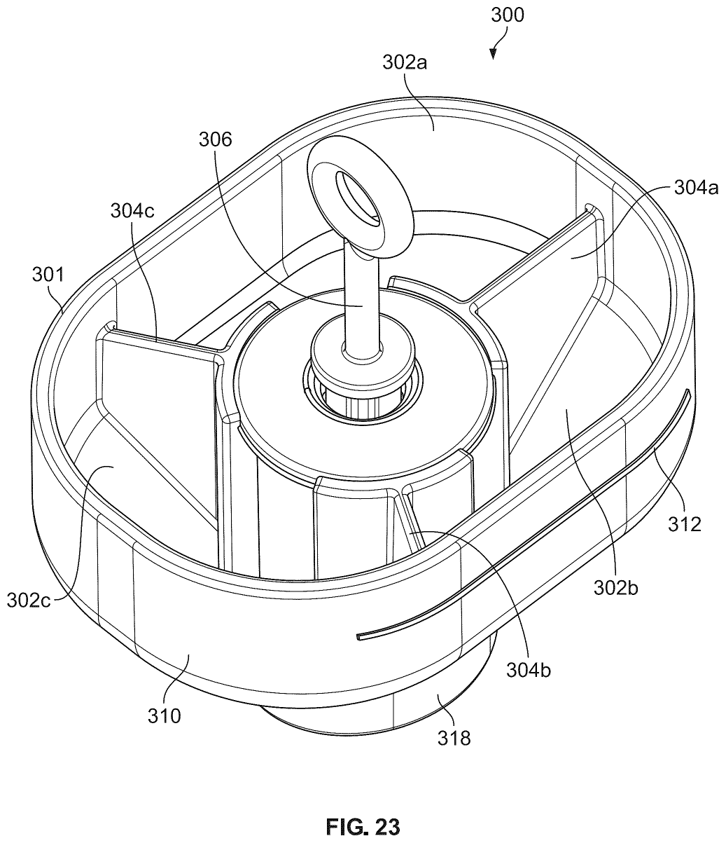

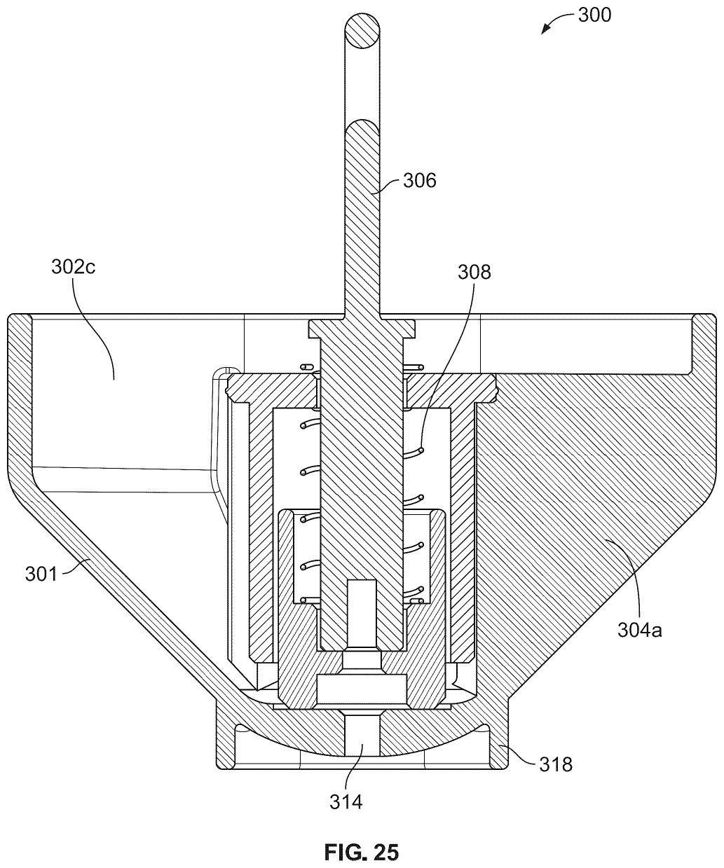

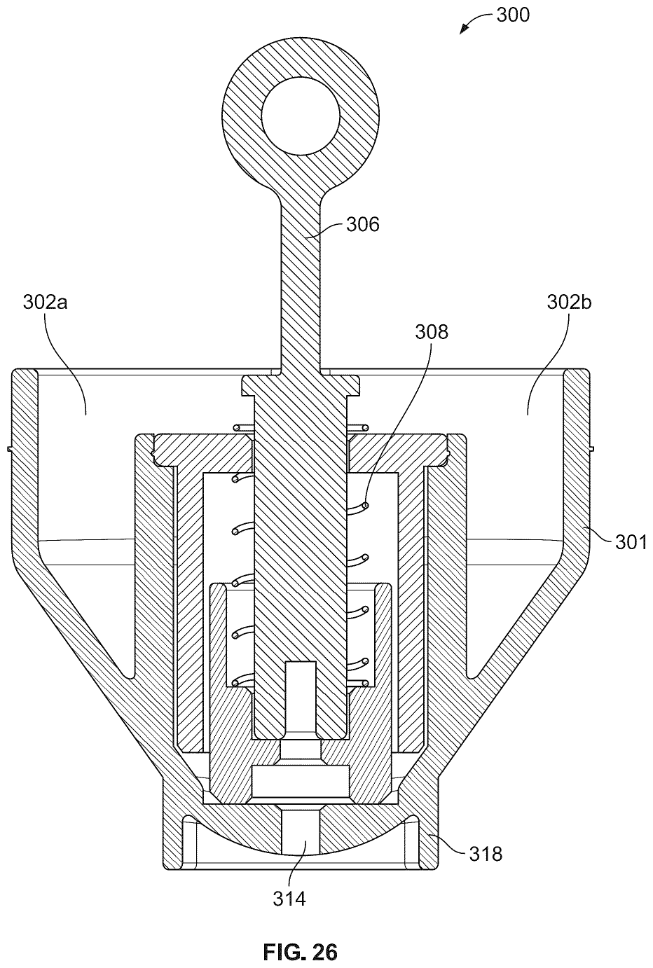

FIGS. 23-26 show an alternative type of pot 300 that may be used with the pendulum decorating apparatus 10 in lieu of pot 22. The pot 300 is similar to the pot 22. Accordingly, only the differences between the pots 22 and 300 are described in detail herein. The pot 300 has a container 301 with three chambers 302a-c for containing a decorating material. The chambers 302a-c are divided by dividers 304a-c. The pot 300 includes a stopper 306 and a spring 308 (FIGS. 25-26) that are structured and operate in a substantially similar manner as the stopper 84 and spring 86 of the pot 22 shown in FIGS. 8-13. A side wall 310 of the container 301 includes a fill line 312 that may provide a user with a visual indication of how much decorating material to put in the container 301. The fill line 312 may be printed, etched, or adhered on the side wall 310, or formed on the side wall 310 in any other suitable manner.

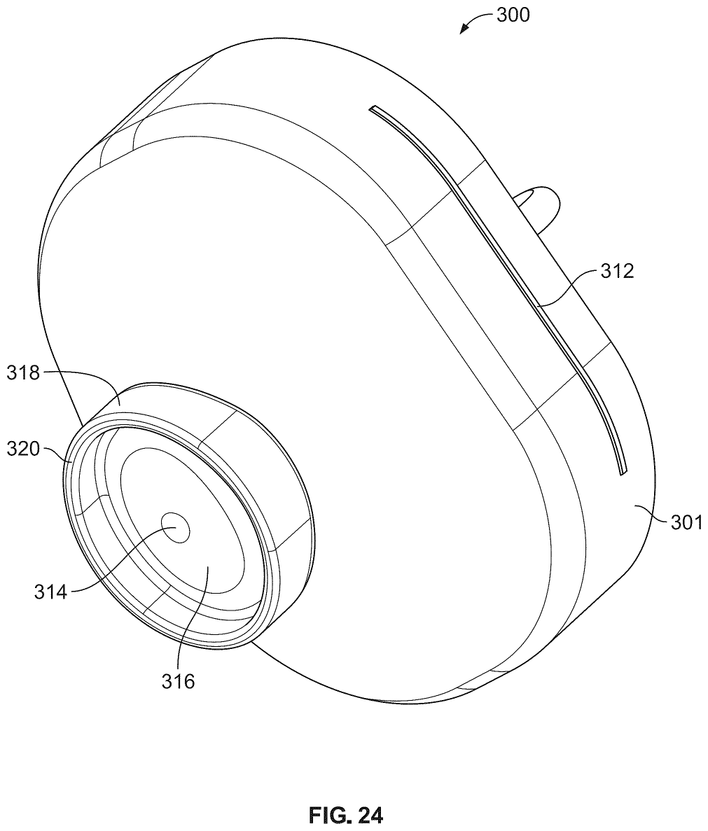

As shown in FIG. 24, the pot 300 includes a single discharge opening 314 formed in a lower wall 316 of the container 301. Decorating material within the chambers 302a-c may be released through the discharge opening 314 when the stopper 306 is in its open position, as described above with respect to the stopper 84 of pot 22. The container 301 further includes a stand 318 that extends downward from the side wall 310 adjacent the lower wall 316. The stand 318 includes a lower edge 320, shown in FIG. 24, that is configured to support the pot 300 on a surface, such as a table top or countertop. The lower edge 320 generally has an oval shape. Except as described herein, the pot 300 is structured and operates in a substantially similar manner as the pot 22 described above.

The components of the pendulum decorating apparatus 10 may be made from any suitable materials. In one exemplary embodiment, the arm 18 may be formed from acrylonitrile butadiene styrene (ABS), the wall sheets 118a-d may be formed from acetate, and the bowl 44, pot 22, base 12, wall inner and outer clips 120 and 122, and tether 20 may be formed from polypropylene (PP). The pot 22, tether 20, and wall sheets 118a-d may be clear.

Further, the components of the pendulum decorating apparatus 10 may have any suitable dimensions. The diameter of the wall 48, the height of the wall 48, and the length of the tether 20 and pot 22 may be configured to retain decorating material released by the pot 22 within the volume of space extending upward from the tilt tray 14 and positioned within the diameter of the wall 48. In other words, the pendulum decorating apparatus 10 may be configured so that paint or other decorating material being released from the swinging pot 22 is contained by the tilt tray 14 and does not fly over the wall 48 of the tilt tray 14. In one exemplary embodiment, the wall 48 may have a diameter of around 12 inches, the combined length of the tether 20 and pot 22 may be around 7 inches, and the height of the wall 48 may be around 2.5 inches.

In at least one embodiment, the pendulum decorating apparatus 10 is configured to disassemble with the disassembled components of the apparatus being able to fit in a relatively flat and compact space for storage and transport. For example, referring to FIG. 4, the base 12, tray support 36, tilt tray 14, decorating tray 16, posts 62a-b, arm 18, tether 20, pot 22, hanger 70, wall sheets 118a-d, and wall inner and outer clips 120 and 122 may all be disassembled from each other. In at least one embodiment, all of these components may be disassembled and assembled without the use of tools. For example, the components may include snap fit connectors. These components may also be stored and transported or sold in a box as part of a kit that also includes one or more containers of paint, a measuring or mixing cup, and/or items to be decorated (e.g., paper, cardboard, cardstock, or canvas).

In use, the pendulum decorating apparatus 10 is assembled by placing the base 12 on a horizontal surface, such as a tabletop or countertop. The tilt tray 14 is mounted to the base 12, and then the tray support 36 is mounted to the top of the base 12. The wall sheets 118a-d are assembled with the inner and outer clips 120 and 122 as described above, and the wall 48 is placed on top of the tilt tray 14. The posts 62a-b are mounted to the decorating tray 16, and the decorating tray 16 is placed on top of the tray support 36. The arm 18 is mounted to the tilt tray 14. The hanger 70 is mounted to the arm 18, and the tether 20 is mounted to the hanger 70. The pot 22 may then be hung from the tether 20.

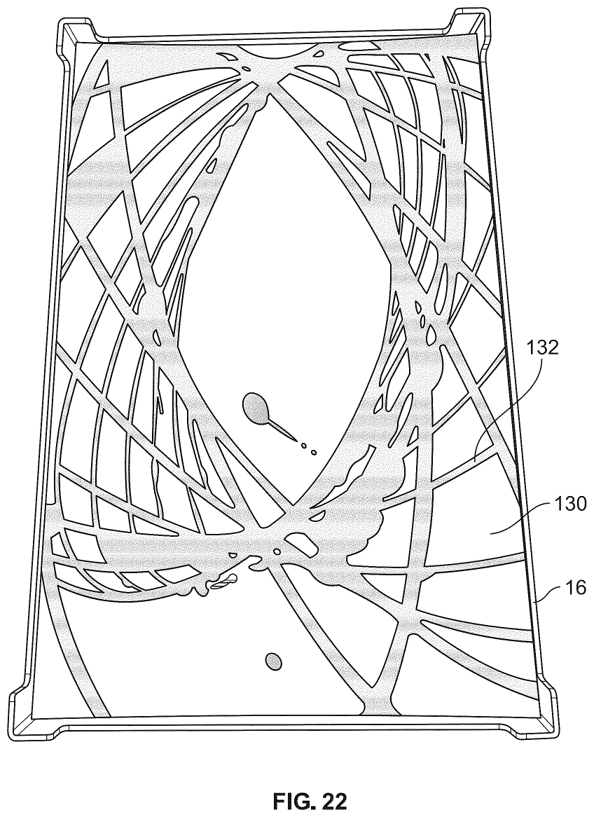

When it is desired to decorate an item with the pendulum decorating apparatus 10, an item for decoration is placed on top of the decorating tray 16. A user may support the pot 22 by the container 82 (FIG. 8) while pouring paint or other decorating materials into the chambers 94a-c. Supporting the pot 22 by the container 82 ensures that the stopper 84 will remain in its closed position blocking the discharge openings 98 (FIG. 9). The pot 22 may be removed from the tether 20 for filling the chambers 94a-c, or it may remain on the tether 20. The pot 22 may be placed on the launch pad 210 (FIG. 20) and filled while the stopper 84 remains in the closed position. Once the pot 22 is filled, the pot 22 and the tether 20 may be pivoted with respect to the hanger 70. For example, the pot 22 and tether 20 may be moved to a position such as shown in FIG. 14 or placed on the launch pad 210 (FIG. 20). The pot 22 is then released or pushed off the launch pad 210 so that the pot 22 swings back and forth above the decorating tray 16 and item placed thereon. When the pot 22 is released, the weight of the decorating material in the pot 22 causes the stopper 84 to move to its open position unblocking the discharge openings 98. The decorating material flows through the discharge openings 98 as the pot 22 swings back and forth over the decorating tray 16. The decorating material is deposited on the item on the decorating tray 16 in a unique pattern as the pot 22 swings. Further, as the pot 22 swings above the decorating tray 16, the tilt tray 14 may be tilted along any axis in the x-z plane (FIG. 3) by utilizing the handles 54a-b. Tilting the tilt tray 14 while the pot 22 swings changes the pivot point of the tether 20 and pot 22, which alters the swing path of the pot 22. The decorating tray 16 may also be rotated while the pot 22 swings to change the position of the decorated item on the tray relative to the swinging pot 22. FIG. 22 shows an exemplary pattern of paint deposited by the pot 22 on cardstock 130 positioned on the decorating tray 16. As shown in FIG. 22, the pattern consists of spaced apart, curved lines, one of which is identified as 132, extending across the cardstock 130.

As the pot 22 swings above the tilt tray 14, paint or other decorating material that is not deposited on the item on the decorating tray 16 is contained within the volume of space above the tilt tray 14 and within the wall 48. The decorating material that is not deposited on the item on the decorating tray 16 may be collected on the tilt tray 14 and poured into another container for re-use. The tilt tray 14, pot 22, tray support 36, wall 48, and decorating tray 16 may be removed from the unit and rinsed clean for storage or re-use. The pendulum decorating apparatus 10 may be disassembled for storage or transport in a reverse manner as described above for assembly of the apparatus.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A pendulum decorating apparatus comprising:
a base;
a tilt tray supported by the base, the tilt tray configured to tilt with respect to the base;
an arm coupled to the tilt tray and extending upward from the tilt tray, the arm configured to tilt with respect to the base when the tilt tray tilts with respect to the base;
a tether coupled to a portion of the arm above the tilt tray; and
a pot coupled to the tether, the pot configured to contain a decorating material, wherein the pot is configured to swing with respect to the arm via the tether while releasing the decorating material through a discharge opening of the pot.

2. The pendulum decorating apparatus of claim 1, wherein the tether extends downward from the arm in a direction parallel to a vertical axis of the base when the tether is not swinging with respect to the arm, and wherein the tilt tray and the arm are configured to tilt with respect to the base about at least a first axis that is perpendicular to the vertical axis.

3. The pendulum decorating apparatus of claim 2, wherein the tilt tray and the arm are configured to rotate with respect to the base about at least a second axis that is parallel to the vertical axis.

4. The pendulum decorating apparatus of claim 1, wherein one of the base or the tilt tray comprises a concave surface and the other of the base or the tilt tray comprises a convex surface that engages the concave surface to allow the tilt tray to tilt with respect to the base.

5. The pendulum decorating apparatus of claim 1, further comprising a decorating tray coupled to the base, the decorating tray positioned above the tilt tray and configured to hold an item for decoration by the decorating material released from the pot.

6. The pendulum decorating apparatus of claim 5, wherein the decorating tray is rotatably mounted to the base, and wherein the decorating tray is configured to rotate with respect to the base separate from the tilt tray tilting with respect to the base.

7. The pendulum decorating apparatus of claim 1, wherein the tether is flexible or rigid.

8. The pendulum decorating apparatus of claim 1, wherein the pot comprises a container that is configured to contain the decorating material and defines the discharge opening, and wherein the pot comprises a stopper that is movable with respect to the container between a closed position, in which the stopper blocks the discharge opening to substantially prevent the decorating material from being released through the discharge opening, and an open position, in which the decorating material can be released through the discharge opening.

9. The pendulum decorating apparatus of claim 8, wherein the stopper is biased to the closed position.

10. The pendulum decorating apparatus of claim 9, wherein the pot comprises a spring that engages the container and the stopper, wherein the spring exerts a bias force on the stopper to bias the stopper to the closed position, wherein the stopper is coupled to the tether, and wherein the stopper is configured to move to the open position when the weight of the container and the decorating material in the container is greater than the bias force of the spring.

11. The pendulum decorating apparatus of claim 1, wherein the pot comprises a plurality of chambers each configured to contain a different color or type of decorating material, wherein each of the chambers is in fluid communication with the discharge opening or another discharge opening defined by the pot.

12. The pendulum decorating apparatus of claim 1, further comprising a wall coupled to the tilt tray and extending upward from the tilt tray.

13. The pendulum decorating apparatus of claim 12, wherein a diameter of the wall, a height of the wall, and a length of the tether are configured to retain decorating material released by the pot within a volume defined by the wall and the tilt tray.

14. A pendulum decorating apparatus comprising:
a base;
a decorating tray supported by the base and configured to hold an item for decoration;
an arm coupled to the base and extending upward above the decorating tray;
a tether coupled to a portion of the arm above the decorating tray; and
a pot coupled to the tether, the pot configured to swing with respect to the arm via the tether, the pot comprising a container that is configured to contain a decorating material and that defines a discharge opening, and the pot comprising a stopper that is movable with respect to the container between a closed position, in which the stopper blocks the discharge opening to substantially prevent the decorating material from being released through the discharge opening, and an open position, in which the decorating material can be released through the discharge opening while the pot swings.

15. The pendulum decorating apparatus of claim 14, wherein the stopper is biased to the closed position.

16. The pendulum decorating apparatus of claim 15, wherein the pot comprises a spring that engages the container and the stopper, wherein the spring exerts a bias force on the stopper to bias the stopper to the closed position, wherein the stopper is coupled to the tether, and wherein the stopper is configured to move to the open position when the weight of the container and the decorating material in the container is greater than the bias force of the spring.

17. The pendulum decorating apparatus of claim 14, wherein the pot comprises a plurality of chambers each configured to contain a different color or type of decorating material, wherein each of the chambers is in fluid communication with the discharge opening or another discharge opening defined by the pot when the stopper is in the open position.

18. The pendulum decorating apparatus of claim 14, wherein the tether is flexible or rigid.

19. The pendulum decorating apparatus of claim 14, wherein the decorating tray is configured to rotate with respect to the base.

20. The pendulum decorating apparatus of claim 14, further comprising a tilt tray supported by the base, the tilt tray positioned below the decorating tray, and the tilt tray configured to tilt with respect to the base.

21. The pendulum decorating apparatus of claim 20, further comprising a wall coupled to the tilt tray and extending upward from the tilt tray.

22. The pendulum decorating apparatus of claim 21, wherein a diameter of the wall, a height of the wall, and a length of the tether are configured to retain decorating material released by the pot within a volume defined by the wall and the tilt tray.

23. A pendulum decorating apparatus comprising:
a base;
a decorating tray supported by the base and configured to hold an item for decoration;
an arm coupled to the base and extending upward above the decorating tray;
a tether coupled to a portion of the arm above the decorating tray; and
a pot coupled to the tether, the pot configured to contain a decorating material, wherein the pot is configured to swing with respect to the arm via the tether, and wherein the pot comprises a plurality of chambers each configured to contain a different color or type of decorating material, each of the chambers in fluid communication with at least one discharge opening of the pot that is configured to release the decorating material contained in the chambers while the pot swings.

24. The pendulum decorating apparatus of claim 23, wherein the tether is flexible or rigid.

25. The pendulum decorating apparatus of claim 23, wherein the decorating tray is configured to rotate with respect to the base.

26. The pendulum decorating apparatus of claim 23, further comprising a tilt tray supported by the base, the tilt tray positioned below the decorating tray, and the tilt tray configured to tilt with respect to the base.

27. The pendulum decorating apparatus of claim 26, further comprising a wall coupled to the tilt tray and extending upward from the tilt tray.

28. The pendulum decorating apparatus of claim 27, wherein a diameter of the wall, a height of the wall, and a length of the tether are configured to retain decorating material released by the pot within a volume defined by the wall and the tilt tray.
